(19) United States
(12) Patent Application Publication
(10) Pub. No.: US 2024/0283086 A1
(43) Pub. Date: Aug. 22, 2024

(54) SYSTEMS FOR FACILITATING BATTERY GAS RELEASE

(71) Applicant: Dell Products L.P., Round Rock, TX (US)

(72) Inventors: Rick C. Thompson, Cedar Park, TX (US); Yan Ning, Cedar Park, TX (US)

(73) Assignee: Dell Products L.P., Round Rock, TX (US)

(21) Appl. No.: 18/172,058

(22) Filed: Feb. 21, 2023

(51) Int. Cl. H01M 50/30; G06F 1/16; H01M 50/105; H01M 50/136; H01M 50/211; H01M 50/247

(52) U.S. Cl. CPC H01M 50/394; G06F 1/1601; G06F 1/1635; H01M 50/105; H01M 50/136; H01M 50/211; H01M 50/247; H01M 2220/30

(57) ABSTRACT

A system can comprise a shell, one or more battery cells disposed within the shell, and a pressure-directing layer disposed between the battery cell(s) and the shell's interior surface. Each of the battery cell(s) can comprise an enclosure including a gas-impermeable portion and a venting portion configured to permit gas to exit the enclosure. The pressure-directing layer can comprise one or more openings that each overlie the venting portion of the enclosure of at least one of the battery cell(s). In some systems, the pressure-directing layer can have a thickness that is less than a distance between the battery cell(s) and the interior surface of the shell such that there is a space between the battery cell(s) and the interior surface of the shell. In some systems, the pressure-directing layer can be coupled to the battery cell(s) and the interior surface of the shell and comprise a resilient material.

### FIELD OF INVENTION

The present invention relates generally to systems for venting gas generated in one or more battery cells.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, including laptops, tablet computers, and mobile devices like smart phones, are conventionally powered by a battery comprising one or more battery cells. Over time, gas may be generated and accumulate in a battery cell, which can degrade the performance thereof and pose a number of issues for the information handling system. For example, gas accumulation may cause the battery cell to expand and impinge on the chassis or one or more components of the information handling system like a touchpad or keyboard; with enough gas accumulation, the pressure the battery cell exerts thereon can cause the chassis to deform or the components to malfunction. Additionally, the swelling may pose safety issues, including if the pressure generated in the battery cell causes it to explode.

Some battery cells include mechanisms to vent gas from the battery cell and mitigate these issues. For example, some battery cells comprise an enclosure having a gas-permeable membrane that allows gas to exit the enclosure when the battery cell balloons. However, such solutions may not fully address the gassing issue. When only a moderate amount of gas is generated, the gas may not readily vent out of the battery cell enclosure because there may not be significant cell ballooning and only a minimal, if any, pressure differential may exist between the exterior and interior of the battery cell's enclosure; without a pressure differential, the gas may not be urged through the gas-permeable portion of the enclosure. As a result, battery cells configured to vent gas out of the enclosure may still exhibit comparable levels of swelling and capacity retention to unvented battery cells with moderate gas generation.

### SUMMARY

Systems described herein can better address gas generation in battery cells with a pressure-directing layer used in conjunction with one or more battery cells that each comprise an enclosure having a venting a portion and a gas-impermeable portion. The pressure-directing layer can be disposed between the battery cell(s) and an interior surface of a shell and can comprise one or more openings that each overlie the venting portion of the enclosure of at least one of the battery cell(s). When gas accumulates in a battery cell, the battery cell can expand from a first thickness to a second thickness and the pressure-directing layer can exert pressure on the gas-impermeable portion of the battery cell's enclosure (e.g., by being pressed between the shell's interior surface and the battery cell). With the pressure-directing layer exerting pressure on the gas-impermeable portion of the enclosure, gas can be directed to the enclosure's venting portion. The concentration of gas at the venting portion can yield a higher pressure differential across the venting portion and thereby promote the venting of gas out of the enclosure through the venting portion and the opening of the pressure-directing layer that overlies it. In this manner, the pressure-directing layer arranged between the battery cell(s) and the interior surface of the shell can better address gas generation in the battery cell(s) and the problems associated therewith.

In some embodiments, a system comprises a shell and one or more, optionally two or more, battery cells disposed within the shell. Each of the battery cell(s), in some embodiments, comprises an enclosure. The enclosure, in some embodiments, includes a gas-impermeable portion and a venting portion that is configured to permit gas to exit the enclosure. In some embodiments, each of the battery cell(s) is a pouch cell, the enclosure of each of the battery cell(s) comprising a flexible film. In other embodiments, the enclosure of each of the battery cell(s) comprises a rigid metallic material.

In some embodiments, the venting portion of the enclosure of each of the battery cell(s) comprises a zeolite material. The zeolite material, in some embodiments, comprises a DDR type zeolite material. In some embodiments, the zeolite material is disposed on an a-alumina substrate. In some embodiments in which the enclosure of each of the battery cell(s) comprises a rigid metallic material, the rigid metallic material is scored in the venting portion of the enclosure. The venting portion of the enclosure of each of the battery cell(s), in some embodiments, is configured to permit carbon dioxide (CO2) to exit the enclosure and inhibit water (H2O) from entering the enclosure.

In some embodiments, each of the battery cell(s) is a lithium-ion battery cell.

In some embodiments, the system comprises a pressure-directing layer that comprises one or more, optionally two or more, openings. Each of the opening(s) of the pressure-directing layer, in some embodiments, overlies the venting portion of the enclosure of at least one of the battery cell(s). In some embodiments, the pressure-directing layer is disposed between the battery cell(s) and an interior surface of the shell. In some embodiments, each of the battery cell(s) has a thickness measured between opposing top and bottom surfaces of the enclosure of the battery cell, and a distance between the battery cell(s) and the interior surface of the shell is between 5% and 15% of the thickness of each of the battery cell(s).

In some embodiments, a thickness of the pressure-directing layer, measured between opposing top and bottom surfaces of the pressure-directing layer, is less than the distance between the battery cell(s) and the interior surface of the shell such that there is a space between the battery cell(s) and the interior surface of the cell. The space, in some embodiments, is defined between the pressure-directing layer and the interior surface of the shell. In some embodiments, the thickness of the pressure-directing layer is between 40% and 80% of the distance between the battery cell(s) and the interior surface of the shell.

In some embodiments, the pressure-directing layer comprising a rigid material, and in other embodiments the pressure-directing layer comprises a resilient material. In some embodiments, the pressure-directing layer comprises a resilient material and is coupled to the battery cell(s) and the interior surface of the shell. The resilient material, in some embodiments, has a shore A durometer that is between 20 and 60 and a shore 00 durometer that is between 60 and 90.

In some embodiments, the system is an information handling system. The information handling system, in some embodiments, comprises a video display and one or more processors electrically coupled to the video display. In some embodiments, the battery cell(s) are electrically coupled to the video display and the processor(s). The information handling system, in some embodiments, comprises a base that contains that battery cell(s) and a keyboard and a touchpad that are each coupled to the base. In some embodiments, the information handling systems comprise a display cover that is coupled to the video display and is movably coupled to the base by a hinge. The base, in some embodiments, comprises the shell, the shell defining an exterior surface of the base.

In some embodiments, the system is a battery assembly. The battery assembly, in some embodiments, is coupled to an information handling system.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified-and includes what is specified; e.g., substantially 90 degrees includes 90 degrees and substantially parallel includes parallel-as understood by a person of ordinary skill in the art. In any disclosed embodiment, the term “about” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” and “include” and any form thereof such as “includes” and “including” are open-ended linking verbs. As a result, a product or system that “comprises,” “has,” or “includes” one or more elements possesses those one or more elements but is not limited to possessing only those elements.

Any embodiment of any of the products and systems can consist of or consist essentially of—rather than comprise/have/include—any of the described elements and/or features. Thus, in any of the claims, the term “consisting of” or “consisting essentially of” can be substituted for any of the open-ended linking verbs recited above in order to change the scope of a given claim from what it would otherwise be using the open-ended linking verb.

Further, a device or system that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1A is a top view of two battery cells usable in some of the present systems, each of the battery cells having an enclosure that includes a gas-impermeable portion and a venting portion to permit gas to exit the enclosure.

FIG. 1B is a top view of a pressure-directing layer usable in some of the present systems.

FIG. 1C is a top view of the pressure-directing layer of FIG. 1B overlying the battery cells of FIG. 1A such that each of the openings of the pressure-directing layer overlies the venting portion of a respective one of the battery cells.

FIG. 2A is a perspective view of a first embodiment of the present systems that is an information handling system (e.g., a laptop) including the battery cells and pressure-directing layer of FIGS. 1A-1C.

FIG. 2B is a top view of a second embodiment of the present systems that is a battery assembly that includes the battery cells and pressure-directing layer of FIGS. 1A-1C.

FIG. 2C is a sectional view of the information handling system of FIG. 2A or the battery assembly of FIG. 2B as taken along line 2C-2C and illustrates how the battery cells and pressure-directing layer are positioned relative to the shell of the information handling system or battery assembly to define a space between the battery cells and the shell when the battery cells each have a first thickness.

FIG. 2D is a sectional view of the information handling system of FIG. 2A or the battery assembly of FIG. 2B as taken along line 2C-2C and illustrates how the pressure-directing layer exerts pressure on the gas-impermeable portion of the battery cells when the battery cells expand to a second thickness.

FIGS. 3A and 3B are sectional views of an information handling system or battery assembly that are substantially the same as those of FIGS. 2A and 2B, except that in the information handling system or battery assembly of FIGS. 3A and 3B the pressure-directing layer comprises a resilient material and is coupled to the battery cells and the interior surface of the shell such that a thickness of the pressure-directing layer decreases when each of the battery cells expands from the first thickness (FIG. 3A) to the second thickness (FIG. 3B).

FIG. 4 is a schematic block diagram of one of the present information handling systems.

### DETAILED DESCRIPTION

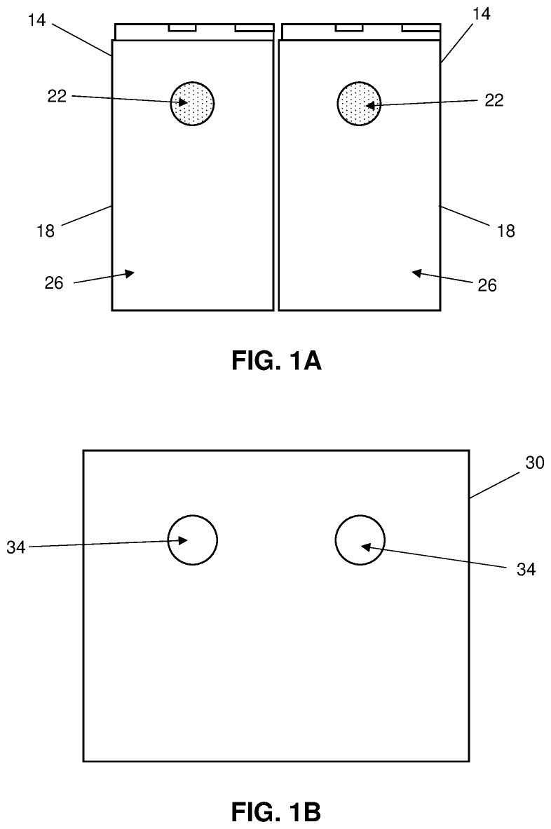

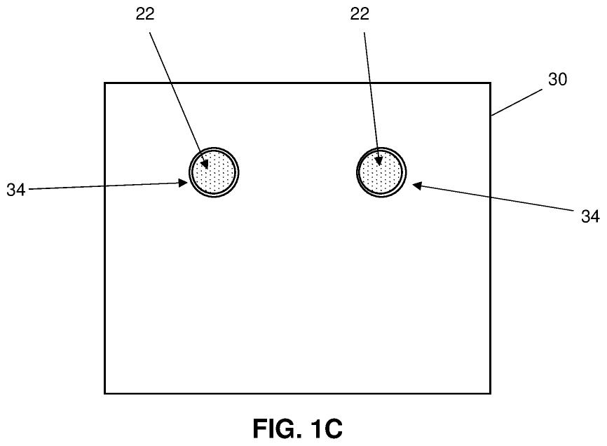

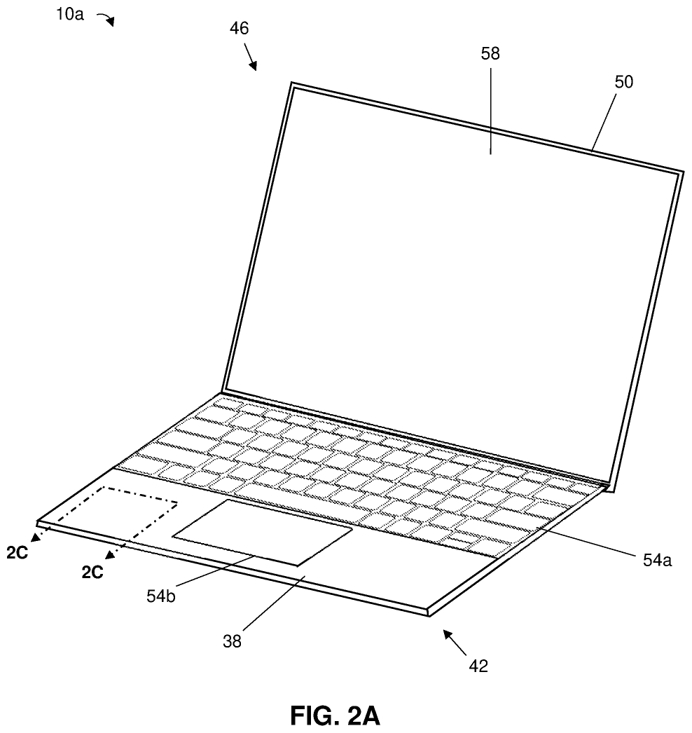

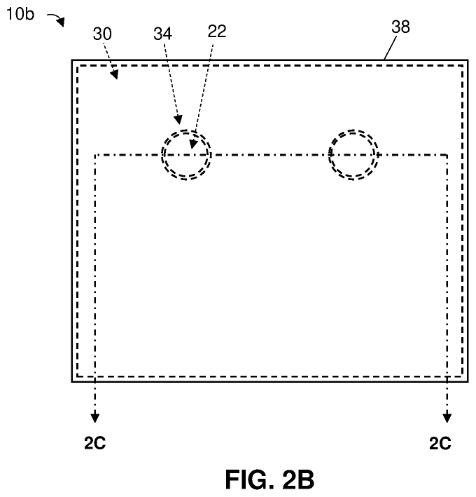

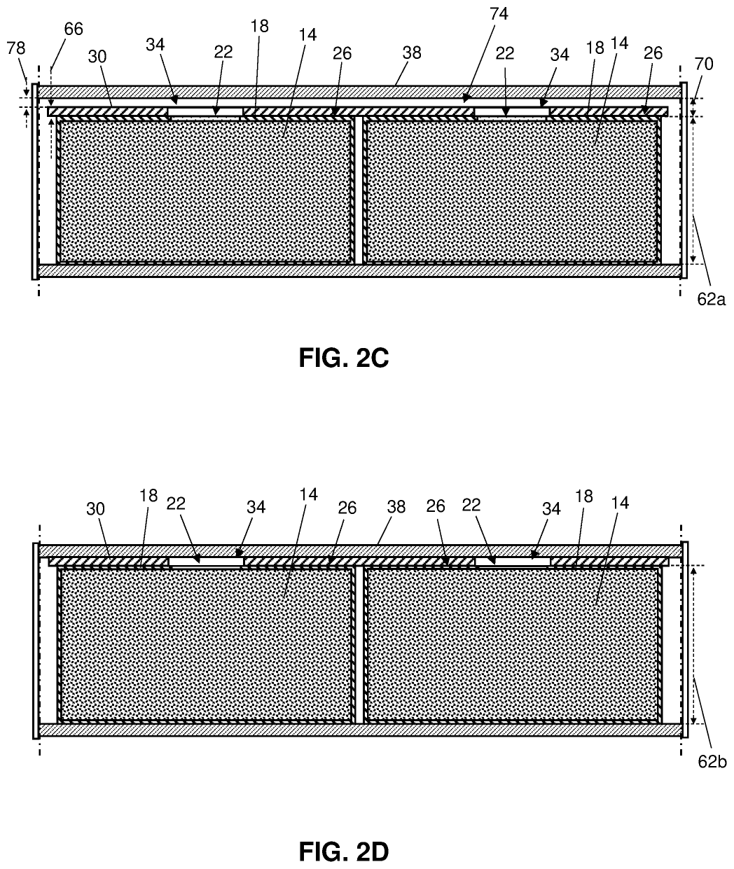

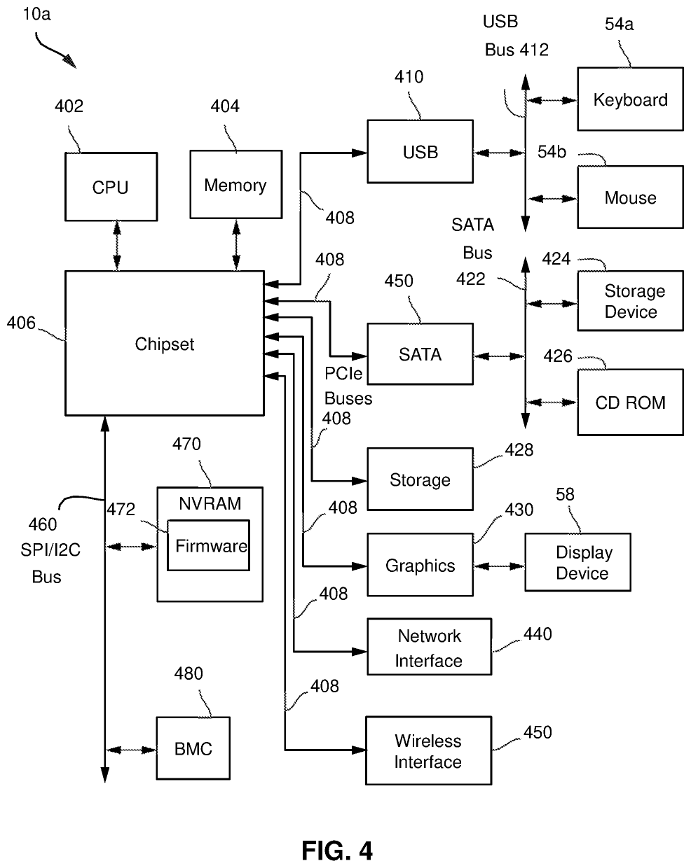

Referring to FIGS. 1A-1C, some of the present systems (e.g., 10a, 10b)—which can comprise, for example, an information handling system (FIGS. 2A and 4) or a battery assembly (FIG. 2B)—can include greater than or equal to any one of, or between any two of, one, two, three, four, five, six, seven, eight, or more (e.g., two or more) battery cells 14 and a pressure-directing layer 30.

As shown, each of battery cell(s) 14 can comprise an enclosure 18 that houses the other components of the battery cell (e.g., an anode, a cathode, an electrolyte, a separator, and/or the like). For example, each of battery cell(s) 14 can be a pouch cell in which enclosure 18 comprises a flexible film (e.g., a polymeric film coated with aluminum such that the aluminum defines an exterior surface of the enclosure), or can be a prismatic or cylindrical cell in which the enclosure comprises a rigid material (e.g., a rigid metallic material like aluminum and/or steel). The material of enclosure 18 can be strong enough to allow pressure-directing layer 30 to exert pressure thereon as described in further detail below without damage being caused thereto; for example, the enclosure can remain undamaged when a pressure that is greater than or equal to any one of, or between any two of, 2, 10, 20, 50, 100, 150, or 200 kilopascals (kPa) (e.g., between 2 and 200 kPa, or between about 0.3 and 30 pounds per square inch) is applied to the enclosure. Battery cell(s) 14 can be rechargeable and can be of any suitable chemistry; for example, each of the battery cell(s) can be a lithium-ion (Li-ion) battery cell (e.g., a lithium-ion polymer battery cell), a nickel-cadmium (NiCad) battery cell, a nickel-zinc (NiZn) battery cell, a nickel metal hydride (NiMH) battery cell, or the like.

As battery cell(s) 14 are used, gas may be generated and accumulate in enclosure(s) 18, which—if unaddressed—can cause the battery cell to expand, degrade the performance of the battery cell, and/or pose safety issues (e.g., by causing the battery cell to explode). For example, if each of battery cell(s) 14 is a lithium-ion battery cell, the chemical decomposition of solvents in the battery cell may result in the generation of carbon dioxide (CO2), at least some of which may be further reduced to carbon monoxide (CO). To mitigate these risks, enclosure 18 of each of battery cell(s) 14 can comprise a venting portion 22 that is configured to permit gas to exit the enclosure. Venting portion 22 can comprise any suitable material to do so, such as a gas-permeable membrane (e.g., a porous membrane) or a scored metallic material. For example, venting portion 22 of each of battery cell(s) 14 can comprise a zeolite material (e.g., a DDR type zeolite material) that is optionally disposed on a porous substrate such as a-alumina. Such gas-permeable membranes may be used with both battery cell(s) 14 that are pouch cell(s) (e.g., having a flexible enclosure 18) and battery cell(s) that are prismatic or cylindrical cell(s) (e.g., having a rigid enclosure). Alternatively, when enclosure 18 comprises a rigid metallic material like steel and/or aluminum (e.g., when battery cell(s) 14 are prismatic or cylindrical cell(s)), the enclosure can be scored in venting portion 22 to allow gas to exit the enclosure through the venting portion as the gas exerts pressure on the venting portion.

While venting portion 22 of each of battery cell(s) 14 is gas-permeable, the venting portion can also be liquid-impermeable to inhibit liquid such as water (H₂O) from entering enclosure 18. Such liquid impermeability can mitigate the risk of damage to each battery cell 14 that might otherwise result from moisture ingress. For example, the pore size of a gas-permeable membrane (e.g., one comprising a zeolite material that is optionally disposed on a porous substrate) used in venting portion 22 can be large enough to permit gas like CO₂ and/or CO to pass therethrough but small enough to inhibit liquid like H₂O from doing the same.

To facilitate the release of gas from battery cell(s) 14, each of enclosure(s) 18 can include a gas-impermeable portion 26 that, as described in further detail below, is configured to interface with pressure-directing layer 30 to direct gas to venting portion 22. Gas-impermeable portion 26 of enclosure 18 can define a majority of the enclosure's exterior surface while venting portion 22 can define a minority of the enclosure's exterior surface, which can promote pressure-directing layer 30′s ability to direct gas toward the venting portion for venting. To illustrate, for each of battery cell(s) 14, venting portion 22 can define less than or equal to any one of, or between any two of, 30%, 25%, 20%, 15%, 10%, or 5% (e.g., less than or equal to 10%) of the exterior surface of enclosure 18 and gas-impermeable portion 26 can define greater than or equal to any one of, or between any two of, 70%, 75%, 80%, 85%, 90%, or 95% (e.g., greater than or equal to 90%) of the exterior surface of the enclosure.

Pressure-directing layer 30 can comprise a layer of material-which can be a rigid material (e.g., a metallic material like aluminum and/or steel) or a resilient material (e.g., an elastomer, gel, and/or foam)-that includes greater than or equal to any one of, or between any two of, one, two, three, four, five, six, seven, eight, or more (e.g., two or more) openings 34, such as one opening for each venting portion 22 of battery cell(s) 14. As shown in FIG. 1C, pressure-directing layer 30 can thus overlie battery cell(s) 14 such that each of opening(s) 34 overlies a venting portion 22 of at least one of the battery cell(s) (e.g., the venting portion of a respective one of the battery cell(s)), thereby allowing gas that exits through the venting portion(s) to flow through the opening(s). For example, in the embodiment shown, pressure-directing layer 30 includes two openings 34, each overlying a respective one of venting portions 22 of the two battery cells 14.

Referring to FIGS. 2A-2D, battery cell(s) 14 and pressure-directing layer 30 can each be disposed within a shell 38 in a manner that allows the pressure-directing layer to direct gas to venting portion 22 of each of the battery cell(s) when gas accumulates therein. As shown in FIG. 2A, shell 38 can be the shell of an information handling system 10a (e.g., that defines an exterior surface of the information handling system, such as the exterior surface of a base 42 of a laptop), which may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific control, or other purposes. For example, information handling system 10a can be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. Information handling system 10a may include random access memory (RAM), one or more processors such as a central processing unit (CPU) or hardware or software control logic, ROM, and/or other types of nonvolatile memory. Additional components of information handling system 10a may include one or more disk drives, one or more network ports for communicating with external devices as well as various input and output (I/O) devices, such as a keyboard, a mouse, touchscreen and/or a video display. Information handling system 10a may also include one or more buses operable to transmit communications between the various hardware components (e.g., to electrically couple the components). One example configuration of information handling system 10a is described with reference to FIG. 4. The hardware components can be electrically coupled to battery cell(s) 14 so that the battery cell(s) can provide power thereto.

In the embodiment shown, information handling system 10a is a laptop that includes—in additional to battery cell(s) 14 as a power source for components of the information handling system and pressure-directing layer 30—a base 42 that comprises shell 38, a display 46 that is movably coupled to the base (e.g., by a hinge) and comprises a display cover 50 and video display 58, one or more processors, a motherboard, one or more user-input devices (e.g., keyboard 54a, touchpad or mouse 54b, and/or the like, which can be coupled to the base), one or more cooling fans, and/or the like.

As shown in FIG. 2B, in other embodiments shell 38 can be the shell of a battery assembly 10b. Shell 38 of battery assembly 10b can itself be configured to be coupled to and/or disposed within a shell of an information handling system (e.g., any of those described herein) such that battery cell(s) 14 can power the information handling system.

Turning to FIGS. 2C and 2D, whether shell 38 is the shell of an information handling system 10a or the shell of a battery assembly 10b, pressure-directing layer 30 can be disposed between battery cell(s) 14 and an interior surface of the shell, with each of the pressure-directing layer's opening(s) 34 overlying a venting portion 22 of at least one of the battery cell(s) as described above. As shown, when gas accumulates in enclosure 18 of a battery cell 14, the battery cell can expand from a first (e.g., unexpanded) thickness 62a (FIG. 2C) (e.g., measured between opposing top and bottom surfaces of the enclosure) to a second (e.g., expanded) thickness 62b (FIG. 2D) that can be, for example, greater than or equal to any one of, or between any two of, 2%, 3%, 4%, 5%, 6%, 7%, 8%, 9%, 10%, or more (e.g., between 3% and 5%) larger than the first thickness. Pressure-directing layer 30 can be configured exert pressure on gas-impermeable portion 26 of battery cell 14 when the battery cell expands to second thickness 62b (e.g., by being pressed between shell 38 and the battery cell). This in turn can direct the accumulated gas to venting portion 22; because the gas is directed to the venting portion that defines only a part of enclosure 18, it exerts a greater pressure on the venting portion than if it was evenly distributed throughout the enclosure, thereby allowing the gas to more readily exit the enclosure through the venting portion.

In the embodiment shown, a thickness 66 of pressure-directing layer 30 (e.g., measured between opposing top and bottom surfaces of the pressure-directing layer) can be less than a distance 70 between battery cell(s) 14 and the interior surface of shell 38 when each of the battery cell(s) has not expanded (e.g., when each of the battery cell(s) has a first thickness 62a) such that there is a space 74 between the battery cell(s) and the shell's interior surface. With pressure-directing layer 30 disposed on battery cell(s) 14 (e.g., as shown), space 74 can be defined between the pressure-directing layer and shell 38's interior surface; in other embodiments, however, the pressure-directing layer can be coupled to the shell's interior surface such that the space is defined between the pressure-directing layer and the battery cell(s). In this manner, battery cell(s) 14 can still expand into space 74 without being impeded by pressure-directing layer 30 as long as the thickness thereof remains below second thickness 62b, as may typically occur during normal cycling of the battery cell(s). However, when enough gas accumulates to cause an undesirable level of expansion (e.g., to second thickness 62b), no portion of space 74 remains such that pressure-directing layer 30 can exert pressure on gas-impermeable portion 26 of each expanded battery cell 14 to promote gas venting as described above.

To illustrate, distance 70 between battery cell(s) 14 and the interior surface of shell 38 can be greater than or equal to any one of, or between any two of, 5%, 6%, 7%, 8%, 9%, 10%, 11%, 12%, 13%, 14%, 15%, 20%, or 25% (e.g., between 5% and 15% or about 10%) of first thickness 62a of each battery cell, and thickness 66 of pressure-directing layer 30 can be less than or equal to any one of, or between any two of, 20%, 15%, 10%, 9%, 8%, 7%, 6%, 5%, 4%, 3%, 2%, or 1% (e.g., less than 10% or between 3% and 5%) of the first thickness, such as less than or equal to any one of, or between any two of, 80%, 70%, 60%, 50%, 40%, or 30% (e.g., between 40% and 80%, between 40% and 60%, or about 50%) of the distance between the battery cell(s) and the shell's interior surface. This can leave a space 74 with a height 78 that is greater than or equal to any one of, or between any two of, 1%, 2%, 3%, 4%, 5%, 6%, 7%, 8%, 9%, 10%, 15%, or 20%, (e.g., between 3% and 5%) first thickness 62a of each battery cell 14 to accommodate normal expansion of the battery cell(s), as may be typical in, for example, Li-ion battery cells. However, any suitable thickness 66 for pressure-directing layer 30, distance 70 between battery cell(s) 14 and shell 38's interior surface, and height 78 of space 74 can be used to accommodate permissible expansion of the battery cell(s).

In these embodiments with a space 74 between battery cell(s) 14 and shell 38's interior surface, pressure-directing layer 30 preferably (but need not) comprises a rigid material (e.g., steel and/or aluminum) to perform its pressure-exerting function when one or more of the battery cell(s) expand (e.g., to the second thickness 62b).

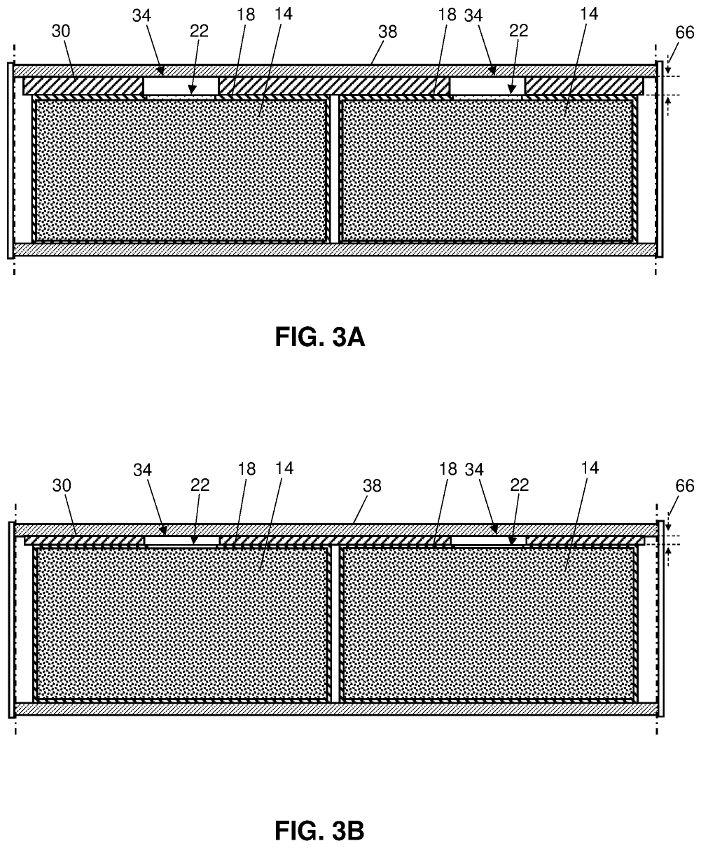

Referring to FIGS. 3A and 3B, in other embodiments there can be no space between battery cell(s) 14 and the interior surface of shell 38, e.g., with pressure-directing layer 30 coupled to both the battery cell(s) and the shell's interior surface even when the battery cell(s) have not yet expanded (e.g., have first thickness 62a) (FIG. 3A). In such embodiments, pressure-directing layer 30 can comprise a resilient (and thus compressible) material such that thickness 66 of the pressure-directing layer can decrease when each of battery cell(s) 14 expands from first thickness 62a (FIG. 3A) to second thickness 62b (FIG. 3B) (e.g., by the difference between the first and second thicknesses, as noted above). With such compressibility, pressure-directing layer 30 can permit battery cell(s) 14 to expand during normal cycling, while also exerting pressure on and thus directing gas to venting portion 22 of an expanded battery cell. To achieve this, the resilient material of pressure-directing layer 30 preferably has a relatively high durometer, such as a shore A durometer that is greater than ore qual to any one of, or between any two of, 20, 30, 40, 50, or 60 (e.g., between 20 and 60) and/or a shore 00 durometer that is greater than or equal to any one of, or between any two of, 60, 65, 70, 75, 80, 85, or 90 (e.g., between 60 and 90). Illustrative resilient materials for such a pressure-directing layer 30 include an elastomer, a gel, a foam, and/or the like.

Referring to FIG. 4, shown in further detail are components of an information handling system 10a that can comprise battery cell(s) 14 and pressure-directing layer 30 in a shell 38. Information handling system 10a may include a processor 402 (e.g., a central processing unit (CPU)), a memory (e.g., a dynamic random-access memory (DRAM)) 404, and a chipset 406. In some embodiments, one or more of processor 402, memory 404, and chipset 406 may be included on a motherboard (also referred to as a mainboard), which is a printed circuit board (PCB) with embedded conductors organized as transmission lines between the processor, the memory, the chipset, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of processor 402, memory 404, chipset 406, and/or other components may be organized as a System on Chip (SoC).

Processor 402 may execute program code by accessing instructions loaded into memory 404 from a storage device, executing the instructions to operate on data also loaded into the memory from a storage device, and generate output data that is stored back into the memory or sent to another component. Processor 402 may include processing cores capable of implementing any of a variety of instruction set architectures (ISAs), such as the x86, POWERPC®, ARM®, SPARC®, or MIPS® ISAs, or any other suitable ISA. In multi-processor systems, each of processors 402 may commonly, but not necessarily, implement the same ISA. In some embodiments, multiple processors may each have different configurations such as when multiple processors are present in a big-little hybrid configuration with some high-performance processing cores and some high-efficiency processing cores. Chipset 406 may facilitate the transfer of data between processor 402, memory 404, and other components. In some embodiments, chipset 406 may include two or more integrated circuits (ICs), such as a northbridge controller coupled to processor 402, memory 404, and a southbridge controller, with the southbridge controller coupled to the other components such as USB 410, SATA 420, and PCIe buses 408. Chipset 406 may couple to other components through one or more PCIe buses 408.

Some components may be coupled to one bus line of PCIe buses 408, whereas some components may be coupled to more than one bus line of PCle buses 408. One example component is a universal serial bus (USB) controller 410, which interfaces chipset 406 to a USB bus 412. A USB bus 412 may couple input/output components such as a keyboard 54a and a mouse 54b, but also other components such as USB flash drives, or another information handling system. Another example component is a SATA bus controller 450, which couples chipset 406 to a SATA bus 422. SATA bus 422 may facilitate efficient transfer of data between chipset 406 and components coupled to the chipset and a storage device 424 (e.g., a hard disk drive (HDD) or solid-state disk drive (SDD)) and/or a compact disc read-only memory (CD-ROM) 426. PCIe bus 408 may also couple chipset 406 directly to a storage device 428 (e.g., a solid-state disk drive (SDD)). A further example of an example component is a graphics device 430 (e.g., a graphics processing unit (GPU)) for generating output to a display device 58, a network interface controller (NIC) 440, and/or a wireless interface 450 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

Chipset 406 may also be coupled to a serial peripheral interface (SPI) and/or Inter-Integrated Circuit (I2C) bus 460, which couples the chipset to system management components. For example, a non-volatile random-access memory (NVRAM) 470 for storing firmware 472 may be coupled to bus 460. As another example, a controller, such as a baseboard management controller (BMC) 480, may be coupled to the chipset 406 through bus 460. BMC 480 may be referred to as a service processor or embedded controller (EC). Capabilities and functions provided by BMC 480 may vary considerably based on the type of information handling system. For example, the term baseboard management system may be used to describe an embedded processor included at a server, while an embedded controller may be found in a consumer-level device. As disclosed herein, BMC 480 represents a processing device different from processor 402, which provides various management functions for information handling system 10a. For example, an embedded controller may be responsible for power management, cooling management, and the like. An embedded controller included at a data storage system may be referred to as a storage enclosure processor or a chassis processor.

System 10a may include additional processors that are configured to provide localized or specific control functions, such as a battery management controller. Bus 460 can include one or more busses, including a Serial Peripheral Interface (SPI) bus, an Inter-Integrated Circuit (I2C) bus, a system management bus (SMBUS), a power management bus (PMBUS), or the like. BMC 480 may be configured to provide out-of-band access to devices at information handling system 10a. Out-of-band access in the context of the bus 460 may refer to operations performed prior to execution of firmware 472 by processor 402 to initialize operation of system 10a.

Firmware 472 may include instructions executable by processor 102 to initialize and test the hardware components of system 10a. For example, the instructions may cause processor 402 to execute a power-on self-test (POST). The instructions may further cause processor 402 to load a boot loader or an operating system (OS) from a mass storage device. Firmware 472 additionally may provide an abstraction layer for the hardware, such as a consistent way for application programs and operating systems to interact with the keyboard, display, and other input/output devices. When power is first applied to information handling system 10a, the system may begin a sequence of initialization procedures, such as a boot procedure or a secure boot procedure. During the initialization sequence, also referred to as a boot sequence, components of system 10a may be configured and enabled for operation and device drivers may be installed. Device drivers may provide an interface through which other components of the system 10a can communicate with a corresponding device. Firmware 472 may include a basic input-output system (BIOS) and/or include a unified extensible firmware interface (UEFI). Firmware 472 may also include one or more firmware modules of the information handling system. Additionally, configuration settings for the firmware 472 and firmware of the information handling system 10a may be stored in the NVRAM 470. NVRAM 470 may, for example, be a non-volatile firmware memory of the information handling system 10a and may store a firmware memory map namespace of the information handling system. NVRAM 470 may further store one or more container-specific firmware memory map namespaces for one or more containers concurrently executed by the information handling system.

Information handling system 10a may include additional components and additional busses, not shown for clarity. For example, system 10a may include multiple processor cores (either within processor 402 or separately coupled to chipset 406 or through the PCIe buses 408), audio devices (such as may be coupled to chipset 406 through one of PCIe busses 408), or the like. While a particular arrangement of bus technologies and interconnections is illustrated for the purpose of example, one of skill will appreciate that the techniques disclosed herein are applicable to other system architectures. System 10a may include multiple processors and/or redundant bus controllers. In some embodiments, one or more components may be integrated together in an integrated circuit (IC), which is circuitry built on a common substrate. For example, portions of chipset 406 can be integrated within processor 402. Additional components of information handling system 10a may include one or more storage devices that may store machine-executable code, one or more communications ports for communicating with external devices, and various input and output (I/O) devices, such as a keyboard, a mouse, and a video display.

In some embodiments, processor 402 may include multiple processors, such as multiple processing cores for parallel processing by information handling system 10a. For example, information handling system 10a may include a server comprising multiple processors for parallel processing. In some embodiments, information handling system 10a may support virtual machine (VM) operation, with multiple virtualized instances of one or more operating systems executed in parallel by the information handling system 10a. For example, resources, such as processors or processing cores of the information handling system may be assigned to multiple containerized instances of one or more operating systems of the information handling system 10a executed in parallel. A container may, for example, be a virtual machine executed by the information handling system 10a for execution of an instance of an operating system by the information handling system. Thus, for example, multiple users may remotely connect to information handling system 10a, such as in a cloud computing configuration, to utilize resources of the information handling system, such as memory, processors, and other hardware, firmware, and software capabilities of the information handling system 10a. Parallel execution of multiple containers by the information handling system 10a may allow the information handling system to execute tasks for multiple users in parallel secure virtual environments.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the products and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus-or step-plus-function limitations, unless such a limitation is explicitly recited in a given claim using the phrase(s) “means for” or “step for,” respectively.

1. A system comprising:
a shell;
one or more battery cells disposed within the shell, each of the battery cell(s) comprising
an enclosure that includes:
a gas-impermeable portion; and
a venting portion that is configured to permit gas to exit the enclosure; and
a pressure-directing layer that:
comprises one or more openings, each of the opening(s) overlying the venting portion of the enclosure of at least one of the battery cell(s);
is disposed between the battery cell(s) and an interior surface of the shell; and
has a thickness, measured between opposing top and bottom surfaces of the pressure-directing layer, that is less than a distance between the battery cell(s) and the interior surface of the shell such that there is a space between the battery cell(s) and the interior surface of the shell.

2. The system of claim 1, wherein the space is defined between the pressure-directing layer and the interior surface of the shell.

3. The system of claim 1, wherein:
each of the battery cell(s) has a thickness measured between opposing top and bottom surfaces of the enclosure of the battery cell; and
the distance between the battery cell(s) and the interior surface of the shell is between 5% and 15% of the thickness of each of the battery cell(s).

4. The system of claim 1, wherein the thickness of the pressure-directing layer is between 40% and 80% of the distance between the battery cell(s) and the interior surface of the shell.

5. The system of claim 1, wherein:
each of the battery cell(s) has a thickness measured between opposing top and bottom surfaces of the enclosure of the battery cell; and
a height of the space between the battery cell(s) and the interior surface of the shell is between 3% and 5% of the thickness of each of the battery cell(s).

6. The system of claim 1, wherein the pressure-directing layer comprises a rigid material.

7. The system of claim 1, wherein each of the battery cell(s) is a pouch cell, the enclosure of each of the battery cell(s) comprising a flexible film.

8. The system of claim 1, wherein the venting portion of the enclosure of each of the battery cell(s) comprises a zeolite material.

9. A system comprising:
a shell;
one or more battery cells disposed within the shell, each of the battery cell(s) comprising
an enclosure that includes:
a gas-impermeable portion; and
a venting portion that is configured to permit gas to exit the enclosure; and
a pressure-directing layer that:
comprises one or more openings, each of the opening(s) overlying the venting portion of the enclosure of at least one of the battery cell(s);
is disposed between the battery cell(s) and an interior surface of the shell such that the pressure-directing layer is coupled to the battery cell(s) and the interior surface of the shell; and
comprises a resilient material.

10. The system of claim 9, wherein the resilient material has:
a shore A durometer that is between 20 and 60; and/or a shore 00 durometer that is between 60 and 90.

11. The system of claim 9, wherein:
each of the battery cell(s) has a thickness measured between opposing top and bottom surfaces of the enclosure of the battery cell; and
a distance between the battery cell(s) and the interior surface of the shell is between 5% and 15% of the thickness of each of the battery cell(s).

12. The system of claim 9, wherein each of the battery cell(s) is a pouch cell, the enclosure of each of the battery cell(s) comprising a flexible film.

13. The system of claim 12, wherein the venting portion of the enclosure of each of the battery cell(s) comprises a zeolite material.

14. An information handling system comprising:
a video display;
one or more processors electrically coupled to the video display;
a shell;
one or more battery cells disposed within the shell and electrically coupled to the video display and the processor(s), each of the battery cell(s) comprising an enclosure that includes:
a gas-impermeable portion; and
a venting portion that is configured to permit gas to exit the enclosure; and
a pressure-directing layer that is disposed between the battery cell(s) and an interior surface of the shell and comprises one or more openings that each overlies the venting portion of the enclosure of at least one of the battery cell(s), wherein the pressure-directing layer:
has a thickness, measured between opposing top and bottom surfaces of the pressure-directing layer, that is less than a distance between the battery cell(s) and the interior surface of the shell such that there is a space between the battery cell(s) and the interior surface of the shell; or
is coupled to the battery cell(s) and the interior surface of the shell and comprises a resilient material.

15. The information handling system of claim 14, comprising:
a base that contains the battery cell(s);
a keyboard and a touchpad that are each coupled to the base; and
a display cover that is coupled to the video display and is movably coupled to the base by a hinge.

16. The information handling system of claim 15, wherein the base comprises the shell, the shell defining an exterior surface of the base.

17. The information handling system of claim 14, wherein:
each of the battery cell(s) has a thickness measured between opposing top and bottom surfaces of the enclosure of the battery cell; and
the distance between the battery cell(s) and the interior surface of the shell is between 5% and 15% of the thickness of each of the battery cell(s).

18. The information handling system of claim 14, wherein each of the battery cell(s) is a pouch cell, the enclosure of each of the battery cell(s) comprising a flexible film.

19. The information handling system of claim 14, wherein the venting portion of the enclosure of each of the battery cell(s) comprises a zeolite material.

20. The information handling system of claim 14, wherein:
the one or more battery cells comprise two or more battery cells; and
the one or more openings of the pressure-directing layer comprise two or more openings.
